(19) United States
(12) Patent Application Publication
(10) Pub. No.: US 2013/0136867 A1
(43) Pub. Date: May 30, 2013

(54) ENVIRONMENTAL FRIENDLY PROCESS FOR MANUFACTURING AND RECYCLING A PAINTED PLASTIC PRODUCT

(71) Applicant: Tiao-Tang Li, New Taipei City (TW)

(72) Inventor: Tiao-Tang Li, New Taipei City (TW)

(21) Appl. No.: 13/747,422

(22) Filed: Jan. 22, 2013

Related U.S. Application Data
(63) Continuation-in-part of application No. 13/183,462, filed on Jul. 15, 2011.

(51) Int. Cl. B29B 17/04

(52) U.S. Cl. CPC B29B 17/04
USPC 427/458

(57) ABSTRACT

An environmental friendly process for manufacturing and recycling a painted plastic product includes several steps: (a) selecting an engineering material, (b) applying the engineering material to a mold for forming a crude product via an injection molding method or a compression molding method, (c) tuning an ambient temperature below 160 Celsius degrees, and spraying a thermosetting powdered paint to coat on the crude product directly by an electrostatic gun so as to form an unfinished product, (d) putting the unfinished product into an oven, and baking the unfinished product for 10 to 15 minutes so as to form the painted plastic product. Under this arrangement, when said steps are applied, the engineering material is molded, sprayed with the thermosetting powdered paint, and baked so as to form the painted plastic product without an introduction of the chemical pretreatment steps.

### CROSS-REFERENCE TO RELATED APPLICATION

This application is a Continuation in part of Ser. No. 13/183,462, filed 15 Jul. 2011, and entitled “ECO-FRIENDLY PROCESS FOR COATING A PLASTIC PRODUCT”, now pending.

### BACKGROUND OF THE INVENTION

1. Field of the Invention

The present invention relates to a process for manufacturing and recycling a painted plastic product, and more particularly to an environmental friendly process for manufacturing and recycling a painted plastic product, in which a chemical pretreatment is omitted and all the steps in the process are physically approached, so that a high recycling yield of the painted plastic product is achieved with no pollution produced.

2. Description of Related Art

Due to the development of the petrochemical industry, the expensive natural materials such as woods and metals are gradually replaced by the cheap plastic materials, so that a variety of plastic products are wildly spread in the markets nowadays. In order to meet the marketing requirements or the product characteristics, the plastic products are further undergone with numerous of processing steps. One of the common traditional processing steps is the surface treatment, which is targeted for meeting the appearance, the corrosion resistance, the wearing resistance or other specific functional requirements; wherein, the surface treatment comprises liquid painting process, coating process (such as electroplating process), chemical oxidation process, thermal spraying process and other procedures in which the chemical or physical methods are participated, so that the plastic product optionally meets the specific functional requirements because of the modification of the surface thereof.

Before the liquid painting process, in order to attach liquid paints firmly onto the plastic products, said plastic products are undergone material pretreatment so as to remove the oxide residues, the sand molding residues, the welding slag, the dusts, the oils or other impurities from the surface of the plastic products. The material pretreatment is roughly divided into three catalogs: the acid-alkali treatment, the surfactant treatment and the organic solvent treatment. The acid-alkali treatment is achieved by applying acidic or basic solutions to react with and dissolve the oxide residues or the oils on the surface of the plastic products so as to clean the surface of the plastic products. Surfactants are the molecules with both the hydrophilic groups and the hydrophobic groups, so that the surfactants are intermiscible with both the organic solutions and the aqueous solutions; thereby, after the surfactant treatment, the oil impurities are removed. The organic solvent treatment is accomplished by applying the organic solvents, such as phenylethylene, tetrachloroethylene, trichloroethylene or ethylene glycol monovinyl ether to the surface of the plastic products, to dissolve the organic impurities retained on the surface of the plastic products.

Although the material pretreatments mentioned above can clean the surface of the plastic products, a plenty of water is essential for rinsing the solvents, solutions or surfactants off the surface of the plastic products during said treatment, so that a wasting of water resource is caused; besides, the chemicals involved in the material pretreatments are not only harmful to human health but also the pollutant to the environments. For instance, chronically inhaling the volatile organic solvents causes human beings being poisoned; even more, it can cause a danger to human life. In addition, once the chemicals are discarded without any proper post treatments, environmental pollutions will be produced, such as water pollution, air pollution, soil pollution and so on, which pollutes and destroys the habitats for the creatures and is a danger to the life for said creatures indeed.

Moreover, after the material pretreatment are done, the following steps of coating are progressed.

Step 1: chemical binding reagents, which are helpful for the attachment of the liquid paints, are applied to the surface of the plastic product.

Step 2: the liquid paints are mixed with solvents, e.g. formaldehyde, benzene or other organic solvents which are intermiscible with the liquid paints, so as to achieve a liquid painting procedure and to form the liquid paints mixtures; and then, the liquid paints mixtures are sprayed on the plastic product.

Step 3: once the liquid paints mixtures cannot cover the surface of the plastic product thoroughly, multiple liquid painting procedures are required, so that a thickness of said liquid paints accumulated on the surface of the plastic product is increased.

Step 4: in order to increase the hardness of the surface of the plastic product, a transparent protecting coating is sprayed onto the surface of the plastic product.

Furthermore, because the liquid paint cannot be thoroughly covered and dispersed uniformly on the surface of the plastic product, during the manufacturing process of said plastic product, color agents are mixed with plastic pellets in a feeding pipe of a manufacturing machine before entering into the injection molding or the compression molding procedures, so that the plastic product is preliminary colored so as to proceed the liquid painting procedure (For example, in order to produce red colored plastic product, white or transparent plastic pellets are mixed with red or orange color agents in the feeding pipe firstly; thereafter, the injection molding or the compression molding procedures are processed by the manufacturing machine so as to produce a preliminary red or orange colored plastic product; thereby, said preliminary colored plastic product are further participated in the liquid painting procedure so as to manufacture the red colored plastic product.); however, regardless of most of the mixture of the color agents and the plastic pellets are released from the feeding pipe after the production of the preliminary colored plastic product, the color agents left in the feeding pipe would be a contaminant for the further production of another plastic product with another color, so that the product quality of said plastic product is decreased; plus, the color agents left would also be a source of corrosion so as to damage the feeding pipe. Under such condition, after the manufacturing process of a batch of preliminary colored plastic products, a cleaning and maintenance procedure is applied to the feeding pipe; typically, two cleaning methods are applied to the manufacturing machine in an individual manner or in a combinative manner. In the first method, the manufacturing machine needs to be shut down, so that operators disassemble spare parts from the manufacturing machine so as to remove said mixture in the feeding pipe and in the manufacturing machine; after the first method is finished, the manufacturing machine is still not ready to be operated until a time period for warming up said manufacturing machine passes; therefore, the first method wastes a lot of electricity, time and manpower. In the second method, instead of shutting down the manufacturing machine, the manufacturing machine is turned on all the time, so that blank plastic pellets are introduced into the feeding pipe, mixed with said mixture and ejected out of the feeding pipe for cleaning the feeding pipe; hence, the second method is expensive and also time taking because of the additional introduction of said blank plastic pellets. Therefore, the cost of the conventional manufacturing process for plastic product is extremely high.

Additionally, after each liquid painting procedure, a baking procedure is followed by so as to fix the liquid paints firmly onto the surface of the plastic product, and each baking procedure takes at least 30 minutes or longer. Besides, as mentioned above, in order to achieve the uniformity of the liquid paint and the smoothness on the surface of the plastic product, multiple liquid painting procedures are necessary for acquiring said uniformity and smoothness. However, since the liquid paints and the organic solvents applied in the liquid painting procedure are unrecyclable, highly volatile and generally toxic, each additional liquid painting procedure generates not only a risk for the healthiness of human beings but also a pollutant for the environments.

Moreover, as mentioned above, before the liquid painting procedure, proper pretreatments are applied to the plastic product firstly; and then, suitable solvents are selected to etch the surface of the plastic product so as to ensure that the liquid paints firmly attach to the surface of the plastic product; therefore, the relationship between the plastic materials and the liquid paints is not merely a physical absorption, but rather a strong chemical binding. In order to accomplish the recycling for the conventional plastic product, wasted plastic product is cracked into wasted plastic particles firstly; and then, wasted paints on the surface of the wasted plastic particles are targeted to be removed; however, because of said pretreatments, the wasted paints are hardly removed from the wasted plastic particles; moreover, when the plastic particles with paint residues are recycled, the chemical and physical properties of the recycled plastic particles are deteriorated and the qualified product rate of the reproduced plastic products is reduced, so that said recycled plastic particles are only applicable for producing low-end products, such as cheap garbage bags, plastic clothes or cushions. While, in order to remove the wasted paints from the plastic particles efficiently, extra chemical procedures are processed which deteriorate the physical and chemical properties again. Therefore, since the recycling process of the conventional plastic products costs lots of time and money, the market applicability of the reproduced plastic products is limited because of said deterioration. Thereby, the conventional plastic products with paints are seldom recycled, so that a plastic pollution issue is generated eventually.

A comprehensive sum up of the disadvantages of the conventional manufacturing process is briefed as following.

Firstly, a plenty of water, electricity and other resources are wasted during said processing steps, the manufacturing process of the plastic product is time consuming because of the involving said processing steps, and the chemical reagents and solvents applied in the material pretreatment steps and liquid painting procedures are unfriendly to the environments and the creatures, some of which are even carcinogens, so that the wastes produced from the material pretreatment steps and the liquid painting procedures must be carefully post-treated so as to reduce the harm to the environments to a lowest level; the described drawbacks induces a further issue: the cost of the manufacturing process of the plastic product becomes high inevitably.

Secondly, because of the material pretreatment steps, the relationship between the plastic materials and the liquid paints is not merely the physical absorption but rather the chemical binding, so that the wasted paints are hardly removed from the wasted plastic particles, and the yield of the recycling is dramatically low. In order to increase the yield of the recycling, said extra chemical procedures are applied so as to remove the wasted paints from the wasted plastic particles efficiently; however said extra chemical procedures not only deteriorate the chemical and physical properties of the reproduced product but also increase the cost of the recycling process. Moreover, because of the involving of the material pretreatment steps during the manufacturing process and the involving of the extra chemical procedures during the recycling process, the recycled plastic particles are not proper to the market requirements and are only applicable for producing the low-end products which lack of economic efficiency.

Thirdly, after the manufacturing process, a cleaning and maintenance procedure is applied so as to prevent the feeding pipe from being contaminated by the color agents; while said procedure takes time, money and manpower, so that the cost of the conventional manufacturing process for plastic product is extremely high.

Fourthly, in order to achieve the uniformity of the liquid paint and the smoothness on the surface of the plastic product, multiple liquid painting procedures are necessary for acquiring said uniformity and smoothness; however, since the liquid paints and the organic solvents applied in the liquid painting procedure are unrecyclable, highly volatile and generally toxic, each additional liquid painting procedure generates not only a risk for the healthiness of human beings but also a pollutant for the environments.

The present invention has arisen to mitigate and/or obviate the disadvantages of the conventional.

### SUMMARY OF THE INVENTION

The main objective of the present invention is to provide an environmental friendly process for manufacturing and recycling a painted plastic product.

To achieve the objective, an environmental friendly process for manufacturing and recycling a painted plastic product comprises the following steps:

(a) selecting an engineering material, wherein a polymer and a heat-resistant substance are mixed so as to form a thermoplastic material, and a conductive material is added to the thermoplastic material so as to form the engineering material, so that a heat-resist temperature of the engineering material is above 120 Celsius degrees; chemical pretreatment steps are unnecessary before the next manufacturing step is introduced;

(b) applying the engineering material to a mold for forming a crude product via an injection molding method or a compression molding method;

(c) coating the crude product via an electrostatic gun, wherein an ambient temperature is tuned below 160 Celsius degrees and a thermosetting powdered paint is sprayed and coated on the crude product directly via the electrostatic gun so as to form an unfinished product; and

(d) baking the unfinished product in an oven, wherein the unfinished product is put into the oven firstly; and then, the unfinished product is baked for 10 to 15 minutes at a baking temperature in a range of 120 Celsius degrees to 220 Celsius degrees so as to form the painted plastic product;

Wherein, the conductive material is optionally selected from following materials: carbon nanotubes, graphite, carbon fiber materials, carbon element, black dyes contained carbon element or the combination thereof; an electrical resistivity of the thermosetting powdered paint is at a range from 10 ohm to 10¹² ohm; the unfinished product is baked in the oven via a thermal cycling procedure or an infrared baking procedure; the recycling of the painted plastic product are achieved via following recycling steps: (i) cracking the painted plastic product into pieces; (ii) heating the pieces in a recycling pipe in which an operational temperature of the recycling pipe is at a range from 190 Celsius degrees to 260 Celsius degrees, so that the thermosetting powdered paint is departed from the engineering material; because the manufacturing process of the painted plastic product is achieved without the chemical pretreatment steps, the recycling of the painted plastic product is simply accomplished by said recycling steps which are physically approached so that the engineering material and the thermosetting powdered paint are separated efficiently; similarly, the chemical and physical properties of the recycled engineering material are retained because of the omitting of the chemical pretreatment steps, so a high yield, a high value and an efficient usability of the recycled engineering material are achieved simultaneously; the present invention further comprises a dust-collecting equipment collecting the thermosetting powdered paint which is not being coated on the crude product and fallen from the crude product and redelivering said thermosetting powdered paint to the electrostatic gun for using in the coating procedure; the polymer is optionally selected from following materials: ABS, AS, PS, PP, PE, PA, PC, POM, PPE, PPO, TPU, PVC, PET, PBT, PC mixing with ABS or combinations thereof; the heat-resistant substance is optionally selected as glass fiber or heat-resistant agents.

Under this arrangement, when said steps are applied, the engineering material is directly molded via the mold, sprayed with the thermosetting powdered paint via the electrostatic gun, and baked in the oven so as to form the painted plastic product without an introduction of any chemical pretreatment steps; moreover, said steps are proceeded physically, so that the painted plastic product are rapidly produced and no chemical pollution are generated; therefore, because of said steps, an environmental friendly and highly recyclable character is presented in the painted plastic product.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of an environmental friendly process for manufacturing and recycling a painted plastic product of the present invention.

### DETAILED DESCRIPTION OF THE INVENTION

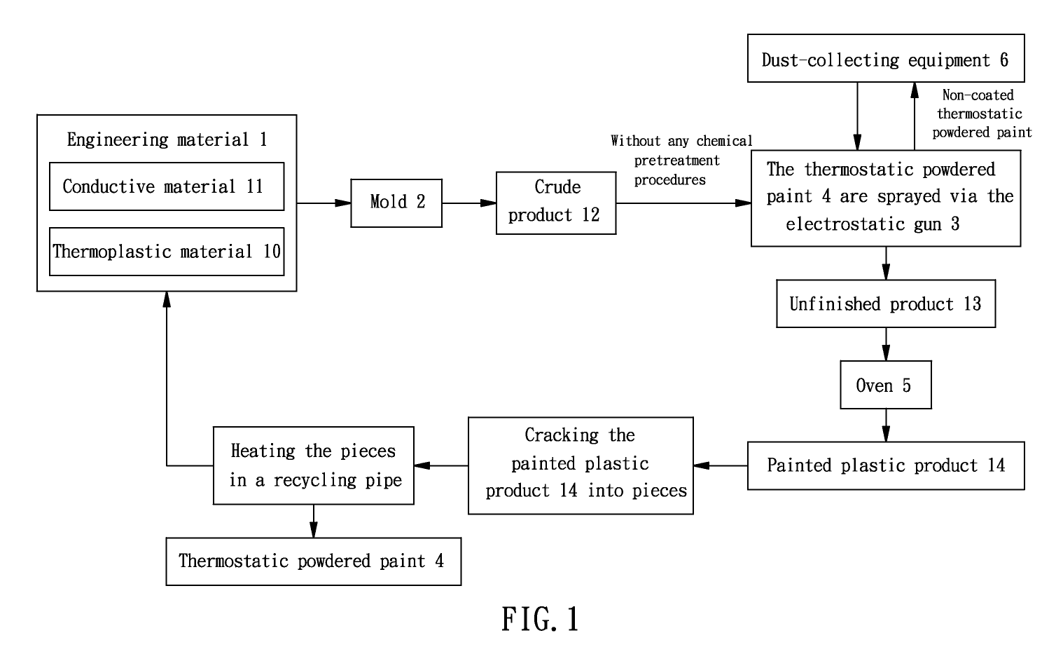

Referring to FIG. 1, an environmental friendly process for manufacturing and recycling a painted plastic product 14 in accordance with the present invention comprises the following steps:

(a) Selecting an engineering material 1: a polymer (not shown) and a heat-resistant substance (not shown) are mixed so as to form a thermoplastic material 10, and a conductive material 11 is added to the thermoplastic material 10 so as to form the engineering material 1, so that the heat-resist temperature of the engineering material 1 is above 120 Celsius degrees; because of the conductive material 11 and a heat-resist temperature of the engineering material 1, chemical pretreatment steps used in prior arts are unnecessary before the next manufacturing step is introduced.

(b) Molding the engineering material 1 via a mold 2: the engineering material 1 is applied to a feeding pipe, so that the engineering material 1 is fed into the mold 2 for forming a crude product 12 via an injection molding method (not shown) or a compression molding method (not shown).

(c) Coating the crude product 12 via an electrostatic gun 3: an ambient temperature is tuned below 160 Celsius degrees and a thermosetting powdered paint 4 is sprayed on the crude product 12 directly via the electrostatic gun 3 so as to coat the thermosetting powdered paint 4 on the crude product 12, the thermosetting powdered paint 4 is electrostatically charged because of the electrostatic gun 3 and is attached on a surface of the crude product 12 physically so as to form an unfinished product 13.

(d) Baking the unfinished product 13 in an oven 5: the unfinished product 13 is put into the oven 5 firstly (For instance, the oven 5 can be a tunnel type baking equipment, but the type of the oven 5 is not limited by the present invention.); and then, the unfinished product 13 is baked for 10 to 15 minutes at a baking temperature in a range of 120 Celsius degrees to 220 Celsius degrees so as to form the painted plastic product 14 (The baking time and the baking temperature depend on the particle size of the thermosetting powdered paint, and the physical and chemical properties of the engineering material 1.).

Under this arrangement, the conductive material 11 is added to the thermoplastic material 10 so as to foam the engineering material 1 firstly; thereby, the engineering material 1 is molded via the mold 2 so as to form the crude product 12; thereafter, without involving any chemical pretreatment steps, the crude product 12 is sprayed with the thermosetting powdered paint 4 directly so as to form the unfinished product 13 (in a preferred embodiment, the spraying of the thermosetting powdered paint 4 is facilitated by the electrostatic gun 3, so that the thermosetting powdered paint 4 is electrostatically charged; therefore, the thermosetting powdered paint 4 is attached onto the surface of the crude product 12 firmly via static electricity); thereby, the unfinished product 13 is baked in the oven 5 so as to form the painted plastic product 14; because said steps are achieved physically and no chemical pretreatment steps are required, the painted plastic product 14 are produced rapidly and no chemical pollutions are generated; therefore, an environmental friendly and highly recyclable character is present in the painted plastic product 14.

The advantages of the present invention are shown as following.

Firstly, because of the omitting of any chemical pretreatment steps, the present invention produces zero pollution; besides, because of the physically but strongly binding relationship between the thermosetting powdered paint 4 and the unfinished product 13, both the engineering material 1 and the thermosetting powdered paint 4 are highly recyclable via a physical manner, wherein recycling percentages of the thermosetting powdered paint 4 and the engineering material 1 are both above 95%.

Secondly, a coating thickness via a conventional liquid painting procedure is typically in a range from 10 micrometers to 30 micrometers. Because of a poor shielding and covering ability of the conventional liquid painting procedure, multiple liquid painting procedures accompanied with multiple baking procedures are processed; therefore, not only a manufacturing time is extended but also environments and creatures are threatened by the spreading of organic solvents or chemicals produced during said liquid painting procedures or baking procedures. Conversely, in the present invention, the thermosetting powdered paint 4 is electrostatically charged and is attached onto the surface of the crude product 12 firmly which involves merely a physically binding relationship; moreover, because a coating thickness via the coating procedure of the present invention is typically in a range from 30 micrometers to 120 micrometers and the thermosetting powdered paint 4 is coated on the surface of the crude product 12 uniformly, one coating procedure accompanied with one baking procedure is enough to cover the crude product 12 well and is uniformly even if the surface of the crude product 12 is unsmooth; moreover, the thermosetting powdered paint 4 provides a beautiful outline and a comfortable handle to the painted plastic product 14. Therefore, the present invention simplifies the manufacturing process, shortens the manufacturing time (a time for a conventional baking procedure is much longer than the time of the baking procedure of the present invention; besides, a conventional manufacturing process needs multiple liquid painting procedures accompanied with multiple baking procedures because of the poor shielding and covering ability of the liquid painting procedure), achieves zero pollution to the environments, so that the cost of the manufacturing process and the energy consumption of the present invention are all reduced.

Thirdly, because the present invention not only has the thicker coating via the coating procedure than the prior arts but also has the thermosetting powdered paint 4 which has better and more uniform shielding and covering ability than the prior arts, no color agents need to be added during the molding procedure of the present invention; therefore, only one designated engineering material 1 (in the preferred embodiment, the designated engineering material 1 is black) needs to be fed into each mold 2 through each feeding pipe during the molding procedure, so that a cleaning and maintenance of said feeding pipe and mold 2 does not need to be applied frequently; moreover, even though the mold 2 suffers some damages under long term use so as to produce one crude product 12 with rough and unsmooth surface, the coating procedure of the present invention is able to cover and shield said rough and unsmooth surface of said crude product 12 uniformly; further, since only one designated engineering material 1 is applied to each feeding pipe, an operator has no chance to misuse the engineering material 1 which probably causes a quality reduction issue to the crude product 12; again, because of the great and uniform covering and shielding ability of the thermosetting powdered paint 4, a precision requirement for the mold 2 is reduced: in the mold 2 designing period, a gate of the mold 2 can be enlarged, and jetting mark, flowing mark and knit line on the mold 2 can be ignored, namely, the precision requirement on a surface smoothness of the mold 2 is rough so that a manufacturing cost of the mold 2 is decreased. Therefore, the present invention simplifies the molding procedure, decreases the frequency of applying the cleaning and maintenance procedure to the feeding pipe and the mold 2, reduces the precision requirement of the mold 2 and lessens the cost as compared to the prior arts.

Fourthly, since no chemical procedures are involved in the present invention, toxic materials, which threaten the healthiness of creatures, are not generated during the coating procedure and baking procedure; moreover, the engineering material 1 and the thermosetting powdered paint 4 of the present invention suffer no risk of explosion so as to be transported by common vehicles and other transportations.

Fifthly, because no organic solvents and water are involved in the present invention, the energy consumption is reduced and therefore the carbon emission of the present invention is also reduced significantly as compared to the prior arts, so that the present invention meets the environmental friendly demand and eliminates the plastic pollution issue.

Further, the details characteristics of the present invention are shown as following.

First, the conductive material 11 is optionally selected from following materials: carbon nanotubes, graphite, carbon fiber materials, carbon element, black dyes contained carbon element or the combination thereof. The polymer is optionally selected from following materials: ABS (Acrylonitrile butadiene styrene), AS (Antistatic polymer), PS (Polystyrene), PP (Polypropylene), PE (Polyethylene), PA (Polyamide), PC (Polycarbonate), POM (Polyoxymethylene), PPE (Polypropylene ether), PPO (Polypropylene oxide), TPU (Thermoplastic polyurethane), PVC (Polyvinyl chloride), PET (Polyethylene terephthalate), PBT (Polybutylene terephthalate), PC mixing with ABS or the combination thereof. The heat-resistant substance is optionally selected from following materials: glass fiber or heat-resistant agents (in the preferred embodiment, the thermoplastic material 10 is formed by mixing PA with glass fiber or by mixing PBT with glass fiber; in addition, fireproof materials can be added to the thermoplastic material 10 in the present invention so as to produce a painted plastic product 14 with a fireproof character.).

Second, the electrical resistivity of the thermosetting powdered paint 4 is at a range from 10 ohm to 10¹² ohm.

Third, the unfinished product 13 is baked in the oven 5 via a thermal cycling procedure or an infrared baking procedure. The baking temperature is in a range from 120 Celsius degrees to 220 Celsius degrees and a melting point of the unfinished product 13 is 140 Celsius degrees. Therefore, when the baking temperature is higher than 140 Celsius degrees, inside the unfinished product 13, the surface of the crude product 12 starts to melt so as to generate a glue like surface; while because of the intrinsic properties for thermosetting materials, the thermosetting powdered paint 4 remains to be solid so as to form a shell which covers the crude product 12; thereafter, the surface of the crude product 12 firmly combines with an inner wall of the shell; thereby, when the temperature decreases, the surface of the crude product 12 starts to solidify again, so that the thermosetting powdered paint 4 is securely fixed on the surface of the crude product 12 so as to generate the painted plastic product 14. Therefore, the thermosetting powdered paint 4 covers the surface of the crude product 12 completely and the manufacture of the painted plastic product 14 is easier and faster than the prior arts.

Referring to FIG. 1, steps and details of a recycling procedure of the painted plastic product 14 are described in order as following.

Firstly, the painted plastic product 14 is cracked into pieces so as to form a plurality of painted plastic particles (not shown).

Secondly, the painted plastic particles are heated in a recycling pipe (not numbered), so that the thermosetting powdered paint 4 is departed from the engineering material 1; wherein an operational temperature of the recycling pipe is at a range from 190 Celsius degrees to 260 Celsius degrees. Because the manufacturing process of the painted plastic product 14 is achieved without the chemical pretreatment steps, the recycling of the painted plastic product 14 is simply accomplished by said recycling steps which are physically approached so that the engineering material 1 and the thermosetting powdered paint 4 are separated efficiently; similarly, the chemical and physical properties of an recycled engineering material 1 are retained because of the omitting of the chemical pretreatment steps, so a high yield, a high value and an efficient usability of the recycled engineering material 1 are achieved in the present invention. Therefore, the recycled engineering material is further processed and reproduced as one recycled plastic product which meets the market requirements.

Furthermore, the recycling procedure is also applicable to the commercially available product which does not encounter any chemical pretreatments so as to produce a recycled plastic material (not shown); thereby, the heat-resistant substance, the conductive material 11 or both the heat-resistant substance and the conductive material 11 is added into said recycled plastic material so as to produce another recycled plastic product; even more, when the recycled plastic material has similar molecular configuration with the recycled engineering material 1, said recycled plastic material can be mixed with said recycled engineering material 1 firstly; thereafter, the conductive material 11 is added into the mixture of the recycled plastic material and the recycled engineering material so as to produce the other recycled plastic product. Therefore, the application of the recycling procedure of the present invention reduces the consumption of the fossil resources greatly so as to decrease the pollutions to the environments and creates a green earth.

Referring to FIG. 1, the present invention further comprises a dust-collecting equipment 6. The dust-collecting equipment 6 collects the thermosetting powdered paint 4 which is not being coated on the crude product 12 and fallen from the crude product 12 firstly; and then, the dust-collecting equipment 6 redelivers said thermosetting powdered paint 4 to the electrostatic gun 3 for using in the coating procedure. Therefore, the thermosetting powdered paint 4 is not wasted in the present invention.

Although the invention has been explained in relation to its preferred embodiment, it is to be understood that many other possible modifications and variations can be made without departing from the spirit and scope of the invention as hereinafter claimed.

What is claimed is:

1. An environmental friendly process for manufacturing and recycling a painted plastic product comprising the following steps:
(a) selecting an engineering material, wherein a polymer and a heat-resistant substance are mixed so as to form a thermoplastic material, and a conductive material is added to the thermoplastic material so as to form the engineering material, so that a heat-resist temperature of the engineering material is above 120 Celsius degrees; chemical pretreatment steps are unnecessary before the next manufacturing step is introduced;
(b) applying the engineering material to a mold for forming a crude product via an injection molding method or a compression molding method;
(c) coating the crude product via an electrostatic gun, wherein an ambient temperature is tuned below 160 Celsius degrees and a thermosetting powdered paint is sprayed and coated on the crude product directly via the electrostatic gun so as to form an unfinished product; and
(d) baking the unfinished product in an oven, wherein the unfinished product is put into the oven firstly; and then, the unfinished product is baked for 10 to 15 minutes at a baking temperature in a range of 120 Celsius degrees to 220 Celsius degrees so as to form the painted plastic product;
wherein when said steps are applied, the engineering material is directly molded via the mold, sprayed with the thermosetting powdered paint via the electrostatic gun, and baked in the oven so as to form the painted plastic product without an introduction of any chemical pretreatment steps; moreover, said steps are proceeded physically, so that the painted plastic product are rapidly produced and no chemical pollution are generated; therefore, because of said steps, an environmental friendly and highly recyclable character is presented in the painted plastic product.

2. The environmental friendly process for manufacturing and recycling a painted plastic product as claimed in claim 1, wherein the conductive material is optionally selected from following materials: carbon nanotubes, graphite, carbon fiber materials, carbon element, black dyes contained carbon element or the combination thereof.

3. The environmental friendly process for manufacturing and recycling a painted plastic product as claimed in claim 1, wherein an electrical resistivity of the thermosetting powdered paint is at a range from 10 ohm to 10¹² ohm.

4. The environmental friendly process for manufacturing and recycling a painted plastic product as claimed in claim 1, wherein the unfinished product is baked in the oven via a thermal cycling procedure or an infrared baking procedure.

5. The environmental friendly process for manufacturing and recycling a painted plastic product as claimed in claim 1, wherein the recycling of the painted plastic product are achieved via following recycling steps:
(i) cracking the painted plastic product into pieces;
(ii) heating the pieces in a recycling pipe in which an operational temperature of the recycling pipe is at a range from 190 Celsius degrees to 260 Celsius degrees, so that the thermosetting powdered paint is departed from the engineering material because the manufacturing process of the painted plastic product is achieved without the chemical pretreatment steps, the recycling of the painted plastic product is simply accomplished by said recycling steps which are physically approached so that the engineering material and the thermosetting powdered paint are separated efficiently; similarly, the chemical and physical properties of the recycled engineering material are retained because of the omitting of the chemical pretreatment steps, so a high yield, a high value and an efficient usability of the recycled engineering material are achieved simultaneously.

6. The environmental friendly process for manufacturing and recycling a painted plastic product as claimed in claim 1, wherein the present invention further comprises a dust-collecting equipment collecting the thermosetting powdered paint,which is not being coated on the crude product and fallen from the crude product and redelivering said thermosetting powdered paint to the electrostatic gun for using in the coating procedure.

7. The environmental friendly process for manufacturing and recycling a painted plastic product as claimed in claim 1, wherein the polymer is optionally selected from following materials: ABS, AS, PS, PP, PE, PA, PC, POM, PPE, PPO, TPU, PVC, PET, PBT, PC mixing with ABS or combinations thereof.

8. The environmental friendly process for manufacturing and recycling a painted plastic product as claimed in claim 1, wherein the heat-resistant substance is optionally selected as glass fiber or heat-resistant agents.
